(19) United States
(12) Patent Application Publication
(10) Pub. No.: US 2013/0053488 A1
(43) Pub. Date: Feb. 28, 2013

(54) FLAME RETARDANT ENCAPSULANT COMPOSITION

(71) Applicants: Haohao Lin, Austin, TX (US); Eumi Pyun, Austin, TX (US); William V. Dower, Austin, TX (US); Zhiqiang Gong, Shanghai (CN); Zhiyong Xu, Shanghai (CN)

(72) Inventors: Haohao Lin, Austin, TX (US); Eumi Pyun, Austin, TX (US); William V. Dower, Austin, TX (US); Zhiqiang Gong, Shanghai (CN); Zhiyong Xu, Shanghai (CN)

(73) Assignee: 3M INNOVATIVE PROPERTIES COMPANY, ST. PAUL, MN (US)

(21) Appl. No.: 13/643,791

(22) PCT Filed: May 10, 2010
(86) PCT No.: PCT/CN10/00652

§ 371 Date: Oct. 26, 2012

(51) Int. Cl. C08K 5/523; C08L 67/00

(52) U.S. Cl. 524/127; 524/599

(57) ABSTRACT

The present invention provides a flame retardant encapsulant composition. A composition includes 40-80 wt. % of an encapsulant comprising 60 to 80 parts by weight of hydrocarbon oil suspended in a cross-linked polymer matrix; and a liquid flame retardant. At least a portion of the liquid flame retardant can be present in the form of a dispersed liquid phase suspended in a continuous oil-rich phase that swells the cross-linked polymer matrix. In some exemplary embodiments, the oil-rich phase comprises less than 15% of the liquid flame retardant dissolved in the oil-rich phase.

### TECHNICAL FIELD

The present disclosure broadly relates to compositions of an encapsulant including a crosslinked polymer network, oil, and a liquid flame retardant. The present disclosure also relates to methods of making the compositions and uses of the compositions.

### BACKGROUND

In telecommunication and electronic applications, encapsulating compositions or materials are often used to provide an environmental barrier to water, moisture, and contaminants. Encapsulants are typically used to encapsulate a device, such as a splice between one or more conductors or an electronic component, through which a signal, such as an electrical or optical signal, is transmitted. The encapsulant serves as a barrier to fluid and non-fluid contamination. In this use and others, it is desirable that the encapsulant be non-toxic, odorless, easy to use, resistant to fungi, and inexpensive.

Encapsulants suitable for many telecommunication applications are frequently oil-based systems. Types of oil-based encapsulants include silicone oil-based gels and hydrocarbon oil-based gels. The encapsulant typically includes a crosslinked polymer network swelled with oil which is essentially inert with respect to the formation of the polymer network. The polymer network may be physically or chemically crosslinked.

Refined petroleum oils and vegetable oils are usually preferred diluents for encapsulants based on the cost. However, the flammability of the resulting encapsulant materials can limit the applications and locations where the encapsulant can be used.

Therefore, an encapsulant prepared using petroleum and/or vegetable oil(s), having improved flammability characteristics is highly desirable. In an effort to address this issue, solid flame retardants have been added to some oil gel materials (i.e. an encapsulant material based on a physically crosslinked polymer network swollen with a hydrocarbon oil) to improve the flame retardant properties of the oil gel material. Addition of high concentrations of solid flame retardants may adversely affect the material properties of the encapsulant material such as by increasing the viscosity of the material before cure and/or modulus of the resulting material. Sometimes these difficulties can be reduced in factory dispensed systems where production equipment or process changes can accommodate for the changes in material properties.

However, an increase in viscosity is usually undesirable in encapsulant formulations which are prepared and dispensed in the field. This is particularly true for multi-part encapsulant systems where a significant increase in the viscosity of the materials can interfere with the required mixing resulting in incomplete curing of the polymer network of the encapsulant.

### SUMMARY

The present invention provides a flame retardant encapsulant composition. A composition includes 40-80 wt. % of an encapsulant comprising 60 to 80 parts by weight of hydrocarbon oil suspended in a cross-linked polymer matrix; and a liquid flame retardant. At least a portion of the liquid flame retardant can be present in the form of a dispersed liquid phase suspended in a continuous oil-rich phase that swells the cross-linked polymer matrix. In some exemplary embodiments, the oil-rich phase comprises less than 15% of the liquid flame retardant dissolved in the oil-rich phase. While in other embodiments, the oil-rich phase comprises less than 10% of the liquid flame retardant dissolved in the oil-rich phase.

In yet another an alternative embodiment, the composition includes 40-70 wt. % of an encapsulant comprising an admixture of 20 to 40 parts by weight of an anhydride functionalized compound, 60 to 80 parts by weight of hydrocarbon oil, and a liquid flame retardant.

In some embodiments, the liquid flame retardant is one of a bisphenol A bis-(diphenyl phosphate) and a resorcinol bis-(diphenyl phosphate). In some embodiments, the composition includes between about 30% by weight and about 60% by weight liquid flame retardant. While in other embodiments, the composition includes between about 40% by weight and about 50% by weight liquid flame retardant.

Compositions according to the present disclosure are useful; for example, as an encapsulant (e.g., a re-enterable encapsulant) for optical or electrical connections such as telecommunication connections and/or electrical circuits or devices.

“Encapsulant” means a semisolid crosslinked material that can resist some mechanical stress without permanent deformation.

“Essentially inert” as used herein means that the plasticizer does not become chemically cross-linked into the polymer network which provides the mechanical structure of the encapsulant material.

“Non-exuding” as used herein means that the plasticizer has the ability to become and remain blended with the unreacted precursors of the crosslinked polymer, and the crosslinked polymer itself, (e.g. an anhydride functionalized compound and a cross-linking agent) and is substantially resistant to weeping or seeping out of the encapsulant material.

“Anhydride functionalized compound” as used herein is defined as a polymer, oligomer, or monomer, which has multiple anhydride reactive sites thereon.

### BRIEF DESCRIPTION OF THE DRAWINGS

The present invention will be further described with reference to the accompanying drawings, wherein:

FIG. 1 shows a schematic view of an exemplary encapsulant material in accordance with the present invention.

FIG. 2 shows a graph which compares the storage modulus (G′) at different Shear Frequencies of an exemplary encapsulant material to a control materials which does not contain any flame retardant.

FIG. 3 shows a scanning electron micrograph of an exemplary encapsulant material in accordance with the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

As polymer and polymer-based materials become more ubiquitous, it can be advantageous to provide enhanced flammability characteristics to the polymer material, especially in the case where these materials may be used or deployed in the vicinity of a combustion source such as an electric current. Underwriters Laboratories (UL) is an independent product safety certification organization, which creates standards and provides fire protection testing and approval procedures.

Flame resistance or ignition resistance for plastics or polymer based materials refers to the tendency of a thin strip of material to withstand a brief exposure to a controlled flame or hot wire without continuing to burn based on the UL standard test methods. For polymer materials, three basic flammability tests are used to measure flame resistance that are part of UL's UL94 flammability standard: Horizontal Burning Test, Vertical Burning Test (20 mm, 125 mm or thin material) and Radiant Panel Flame Spread Test. The horizontal burning test is generally considered the easiest flammability test to pass. The vertical burning test is more stringent than the horizontal burning test and has three classification levels: 94V-2 (lowest level), 94V-1 and 94V-0 (highest level). Materials that pass a UL94 vertical burn test are classified as self extinguishing (i.e. burning stops when the ignition source is removed).

Compositions according to the present disclosure are useful; for example, as an encapsulant (e.g., a re-enterable encapsulant) for optical or electrical connections such as telecommunication connections and/or electrical circuits or devices. In particular, encapsulants of the current disclosure can be used as sealing gels, and/or potting materials that are included in electrical connectors (e.g., telecommunications connectors), splice closures, and electrical circuits (e.g., on a printed circuit board such as a personal computer mother board or in electronic sensor modules). For example, the compositions may be used to protect detectors for vehicles, especially train or traffic sensors; control circuits or power circuits which are deployed in extreme environments (e.g. in and/or around hot tubs, spas or pools); or for pumps or electrically controlled valves which are immersed in fountains, water supply equipment or in the sumps of boats. For the purposes of the present disclosure, the encapsulant is a material which provides a seal which blocks the entry of water, dirt, cleaning solutions, or other environmental contamination.

Compositions according to the present disclosure are encapsulant materials. In one particular aspect, the encapsulant can be a multi-part reactive encapsulant material that can be mixed and dispensed in a factory or in the field. The encapsulant material of the present invention is suited for use as an encapsulant for signal, control or power transmission devices and other uses in which a flame retardant, water-impervious barrier is desired. One exemplary encapsulant material can be formed by cross-linking an anhydride functionalized compound with a suitable cross-linking agent in the presence of an organic plasticizer (e.g. oil) which extends the reaction product. The plasticizer is preferably essentially inert to the reaction product and substantially non-exuding. The plasticizer system chosen contributes to the desired properties of the encapsulant, such as, the degree of adhesion to grease-coated conductors, the degree of compatibility with standard telecommunication or electrical connectors, and the softness or hardness of the encapsulant. Many excellent plasticizers experience some blooming, or a slight separation from the solid, especially at higher temperatures or when under compression, and over lengthy storage times. These plasticizers are still considered to be ‘substantially non-exuding’.

An exemplary encapsulant can include an oil swollen, cross-linked polymer network. The cross-links can be either due to physical association or chemicals bonds formed between the polymer chains within the network. For example, an exemplary composition for an encapsulant can comprise a base encapsulant material comprising an extended reaction product of an admixture of: 1) an anhydride functionalized compound having reactive anhydride sites; 2) a crosslinking agent which reacts with the anhydride sites of the anhydride functionalized compound; 3) a hydrocarbon oil which acts as plasticizer and is essentially inert to the reaction product and substantially non-exuding; and a flame retardant which is also essentially inert to the cross-linking reaction which forms the resulting encapsulant material. For example, the hydrocarbon oil can be a petroleum based mineral oil, a vegetable oil or a modified version of either of these two oil types. Other additives which may be added to the exemplary encapsulant of the current invention include cure catalysts, stabilizers, antioxidants, biocides, colorants, thermally conductive fillers, etc.

An exemplary commercially available base encapsulant material include, but are not limited to those available under the trade designation High Gel Re-enterable Encapsulant 8882, available from 3M Company (St. Paul, Minn.).

Exemplary flame retardants useful in this encapsulant composition should be inert with respect to the reaction(s) which form the cross-linked polymer network, so as to not inhibit, reduce the number of cross links, or significantly change the reaction time for the formation of the cross-linked polymer network. In one aspect, the exemplary flame retardants can include phosphorous-based liquid flame retardants. Exemplary phosphorous-based liquid flame retardants include bisphenol A bis-(diphenyl phosphate) such as REOFOS® BAPP available from Chemtura Corporation (Middleubury, Conn.) or BDP available from Jiangsu Yoke Technology Co. Ltd (Shanghai, China) and resorcinol bis-(diphenyl phosphate) also known as RDP such as REOFOS® RDP available from Chemtura Corporation (Middleubury, Conn.), RDP available from Jiangsu Yoke Technology Co. Ltd (Shanghai, China), or FYROLFLEX® RDP available from Supresta (Ardsley, N.Y.).

Bisphenol A bis-(diphenyl phosphate) can be represented by the formula

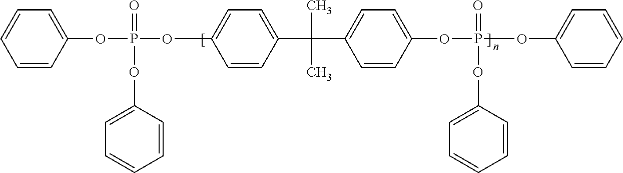

Commercial Bisphenol A bis-(diphenyl phosphate) materials are typically a mixture of oligomers where n−1-2 and comprise 8.9% phosphorus.

Resorcinol bis-(diphenyl phosphate) can be represented by the formula

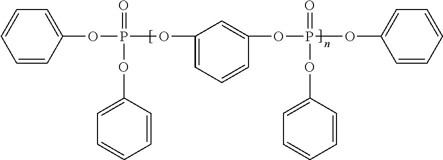

Commercial RDP materials are typically a mixture of oligomers where n=1-3 and comprise 10-12% phosphorus.

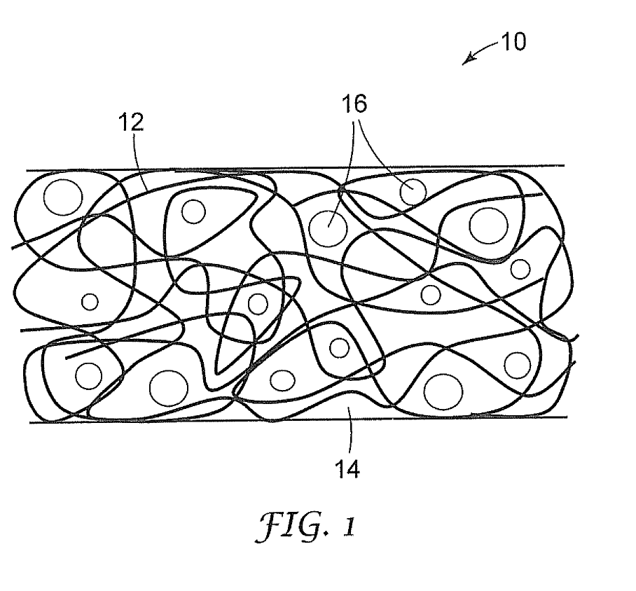

Referring to FIG. 1, an exemplary encapsulant material 10 includes a cross-linked polymer network 12 swollen with a continuous oil-rich phase 14. The liquid flame retardant may be only partially soluble in the oil-rich phase such that the flame retardant forms a second dispersed liquid phase 16 within the continuous oil-rich phase held within the cross-linked polymer network or matrix. In one exemplary embodiment, the oil-rich phase can contain less than 15 wt % of the liquid flame retardant dissolved in the oil-rich phase. In an alternative exemplary embodiment, the oil-rich phase can contain less than 10 wt % of the liquid flame retardant dissolved in the oil-rich phase.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

### Materials Used

High Gel Re-enterable Encapsulant 8882: an encapsulant formed as an admixture of an anhydride functionalized compound, available from 3M Company (St. Paul, Minn.).
REOFOS® BAPP: bisphenol A bis-(diphenyl phosphate), available from Chemtura Corporation (Middleubury, Conn.)
REOFOS® RDP: resorcinol bis-(diphenyl phosphate), available from Chemtura Corporation (Middleubury, Conn.)
RDP: resorcinol bis-(diphenyl phosphate), available from Jiangsu Yoke Technology Co. Ltd (Shanghai, China),
FYROLFLEX® RDP: resorcinol bis-(diphenyl phosphate), available from Supresta (Ardsley, N.Y.).

The 8882 encapsulant is a two-part (part A/part B) reactive encapsulant system. Equal parts (A/B) of the 8882 encapsulant were weighed out. A given weight of flame retardant to be evaluated was added to part A of the encapsulant and then mixed for one minute using a SPEEDMIXER DAC 150FVZ available from FlackTek, Inc. of Landrum, S.C. operating at 3000 rpm. Part B of the encapsulant was added to the resultant mixture and then mixed for one minute at 3000 rpm. The mixture was cast into a silicone mold and cured at room temperature.

For example, to make a 40 wt. % mixture of RDP in the 8882 encapsulant, 20.0 g of RDP from Jiangsu Yoke Technology Co. Ltd (Shanghai, China) was mixed into 15.0 g of Part A for one minute at 3000 rpm. The 15.0 g of Part B was added to the mixture and mixed for one minute at 3000 rpm. The mixture was cast into a silicone mold and cured at room temperature for 24 hours.

Flame retardants were screened for applicability by conducting an abbreviated version of UL94 Vertical Burn Test. Table 1 provides the composition of each material and the screening test results. In contrast to the full test method, the screening test utilized two test specimens preconditioned at 23±2° C. and 50±5% relative humidity for a minimum of 18 hours. Each test specimen was then tested according to UL94 Vertical Burn Test shown below.

### UL94 50 W (20 mm) Vertical Burning Test (ASTM D 3801 or IEC 60695-11-10)

Test specimens were created by casting the encapsulant in a mold to create 125 mm long by 13.0 mm wide by 5 mm thick test specimens. One set of 5 test specimens was preconditioned at 23±2° C. and 50±5% relative humidity for a minimum of 48 hours. One set of 5 test specimens was preconditioned in an air-circulating oven for 168 hours at 70±1° C. and then cooled in a desiccator for at least 4 hours at room temperature, prior to testing.

Each test specimen was arranged so that the longitudinal axis of the specimen extended vertically from the clamp such that the lower end of the specimen is 300±10 mm above a horizontal layer of absorbent 100 percent cotton that was thinned to approximately 50×50 mm and a maximum thickness of 6 mm.

The methane gas burner having a blue flame 20±1 mm high was applied to the broad face of the test specimen near the bottom of the specimen. The burner was moved as necessary in response to any changes in the length or position of the specimen due to shrinkage, distortion or melting. After the application of the flame to the specimen for about 10 seconds, the burner was withdrawn to a distance at least 150 mm away from the specimen. The afterflame time t1 (i.e. the time that the sample continued to burn after removal of the methane flame) was measured.

As soon as the afterflaming of the specimen ceased, the burner was immediately applied for an additional 10 seconds. After this application of the flame to the specimen, the burner was removed and the second afterflame time, t2, and the afterglow time, t3 was measured.

Results of the vertical burning test are recorded as one of three classification levels 94V-2 (lowest level), 94V-1 and 94V-0 (highest level).

Table 1 shows a summary of exemplary flame retardant encapsulant formulations and the results of UL-94 vertical burn test performance. As mentioned above, Table 1 provides the composition of each material based on the screening test results utilizing two test specimens preconditioned at 23±2° C. and 50±5% relative humidity for a minimum of 18 hours with the exception that the 40% sample with the Yoke RDP which was tested to the full UL-94 vertical burn test standard described above.

TABLE 1

| Exp. | | Flame Retardant | Flame Retardant |
|---|---|---|---|
| No. | Flame Retardant | Wt. % | Rating |
| Control | None | 0 | Fail |
| 1 | Yoke RDP | 30 | 94V-2 |
| 2 | | 35 | 94V-2 |
| 3 | | 40 | 94V-0 |
| 4 | Reofos RDP | 35 | 94V-2 |
| 5 | | 40 | 94V-0 |
| 6 | | 50 | 94V-0 |
| 7 | Fyrolflex RDP | 40 | 94V-2 |
| 8 | | 50 | 94V-0 |
| 9 | Reofos BAPP | 40 | 94V-2 |
| 10 | | 50 | 94V-0 |

The visco-elastic properties of encapsulant materials of the type described herein are related to the intrinsic cross-linked structure of the polymer network. This network structure determines the theological behavior of the gel at different temperatures and shear rates. The rheological properties of polymeric based materials such as encapsulants and gels may be measured by methods well known in the art, such as dynamic mechanical analysis (DMA) testing. For example, a Rheometrics RDA-2 Analyzer manufactured by TA Instruments (New Castle, Del.) was used to determine some of the visco-elastic properties of encapsulant materials, including the storage modulus G′ and the loss modulus of the inventive encapsulant materials disclosed herein.

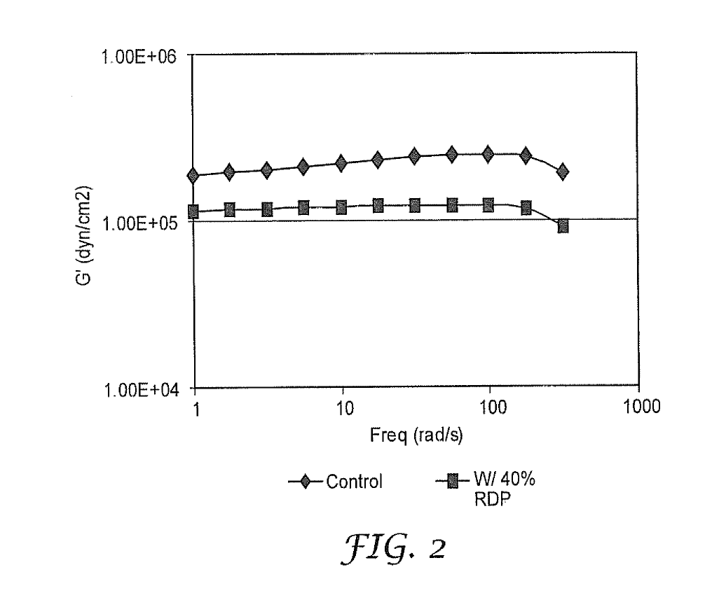

The RDA-2 Analyzer was set up with 25 mm parallel plates which were rotated over a range of angular oscillatory velocities and shear frequencies. FIG. 2 shows a comparison of the storage modulus (G′) as a function of shear frequency at 23° C. of a cured 8882 control sample containing no flame retardant and exemplary 8882 encapsulant sample containing 40 wt. % RDP from Jiangsu Yoke Technology Co. Ltd (Shanghai, China). The behavior at differing shear rates is consistent. The storage modulus of the encapsulant containing the liquid flame retardant is slightly lower than the control sample which can be advantageous in some applications. A lower modulus indicates a softer gel material, which is desirable in some applications that require the gel to be re-enterable.

The slight increase in the softness of the gel can be advantageous in some applications and is counter to what is normally encountered when high levels of solid flame retardants are added to similar encapsulant systems.

The adhesion to steel of a cured 8882 control sample containing no flame retardant and an exemplary 8882 encapsulant sample containing 40 wt. % RDP from Jiangsu Yoke Technology Co. Ltd (Shanghai, China) were measured. Unreacted sample materials were applied to clean steel plates and allowed to cure at 23±2° C. and 50±5% relative humidity for a minimum of 24 hours. After which, the cured samples were removed from the plate by hand. Residual material remained on the steel plate after removal of both materials which indicated the adhesion strength to the steel was higher than the cohesive strength of the material.

The water absorption behavior was tested for a cured 8882 control sample containing no flame retardant and an exemplary 8882 encapsulant sample containing 40 wt. % RDP. Samples with flame retardant were prepared with RDP from Jiangsu Yoke Technology Co. Ltd (Shanghai, China) and with REOFOS® RDP from Chemtura Corporation (Middleubury, Conn.). For this test, a 40 g sample of each material in the form of a 5 cm diameter cylinder was submerged in deionized water for one week. After seven days, the samples were removed, patted dry with tissue paper and the weight gain recorded. All samples showed minimal weight gain due to the absorption of water (e.g. 8882 control sample containing no flame retardant −0.093% and an 8882 encapsulant material sample containing 40 wt. % RDP −0.16% for both of the RDP materials tested).

The relative solubility of RDP was measured in the components of an 8882 encapsulant material (parts A/B). 12.0 g of RDP from Jiangsu Yoke Technology Co. Ltd (Shanghai, China) was mixed with 18.0 g of part A for one minute at 3000 rpm and 12.0 g of RDP from Jiangsu Yoke Technology Co. Ltd (Shanghai, China) was mixed with 18.0 g of part B for one minute at 3000 rpm producing an emulsion having dispersed phase droplets of about 10 microns in diameter as confirmed by scanning electron microscopy (SEM). Both solutions were set aside for one week to settle.

The part A mixture was separated into two layers: a relatively clear layer and a hazy layer. An aliquot of liquid was carefully removed from both layers to avoid intermixing of the layers. A ¹H NMR measurement was done using a Bruker Avance III 500 MHz Nuclear Magnetic Resonance Spectrometer using 5 mm NMR tubes in a broadband BBFO Probe, available from Bruker BioSpin Corporation (Billerica, Mass.), to determine the relative constituents in each layer in the Part A/RDP mixture. The clear layer of the part A/RDP mixture contained 88 wt. % of the 8882 part A material and 12 wt % of RDP. The hazy layer of the part A/RDP mixture contained 33 wt. % of the 8882 part A material and 67 wt. % of RDP.

The part B/RDP mixture was separated into three layers: a relatively clear upper layer, a hazy middle layer and a relatively clear lower layer. An aliquot of liquid was carefully removed from each layer to avoid intermixing of the layers. ¹H NMR was used to determine the relative constituents in each layer in the part B/RDP mixture. The clear upper layer of the part B/RDP mixture contained 96 wt. % of the 8882 part B material and 4 wt. % of RDP. The hazy middle layer of the part B/RDP mixture contained 33 wt. % of the 8882 part B material and 67 wt. % of RDP. The lower layer of the part B/RDP mixture contained 4 wt. % of the 8882 part B material and 96 wt. % of RDP.

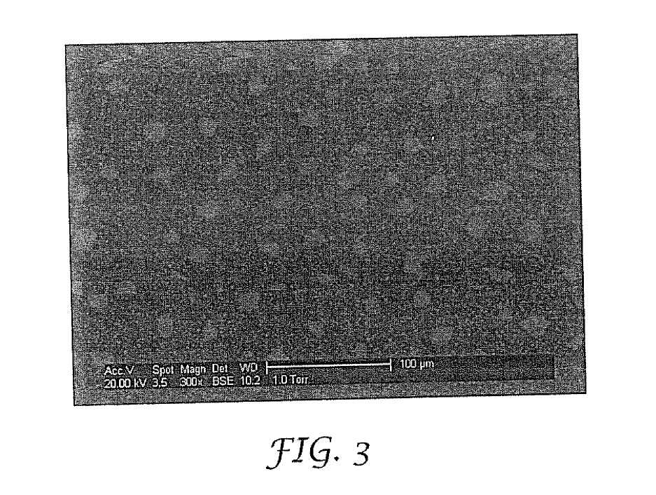

FIG. 3 shows a scanning electron micrograph of an exemplary encapsulant material containing 40 wt. % of RDP. The image was captured using a FEI XL30 Environmental Scanning Electron Microscope (ESEM) available from FEI Company (Hillsboro, Oreg.), operating in low vacuum mode using a backscattered electron imaging (BSEI) technique. The chamber pressure was at 1.0 torr and the beam strength was 20 KV. BSEI can be used to image compositional differences in a sample near its surface. Areas of high average atomic number show up as light areas in BSEI images. Thus, the dispersed light colored regions in the micrograph indicate phosphorus rich regions (e.g. flame retardant rich regions) dispersed within the darker continuous oil rich phase.

When the encapsulant of the current invention is a reactive two part system, it can be used in a myriad of applications where having a low initial viscosity is desirable, such as in applications involving fine features and/or where a plurality of components all need to be encapsulated at one time. The encapsulant can be factory dispensed such as may be required when protecting and sealing electronic assemblies such as electrical connections on circuit boards which are used in sensor assemblies or other applications where they need to be protected from their environment. In these applications, the flame retardant may be premixed into one or both parts of the encapsulant mixture prior to final mixing of the two parts for dispensing in it intended application. Alternatively, the two parts of the encapsulant material and the flame retardant may be simultaneously introduced into the final mixing process just prior to dispensing so long as the constituents are adequately mixed to emulsify the flame retardant in the oil-rich phase of the encapsulant. Alternatively, all of the ingredients of the encapsulant can be mixed together simultaneously in the factory at an elevated temperature until the polymer is dissolved the flame retardant is emulsified in the oil rich phase of the material. This material can then be dispensed into telecommunication modules, electronic sensor modules or other connectors or devices where environmental protection of electrical connections is needed.

In yet another embodiment, the encapsulant of the current invention can be mixed and dispensed in the field such as is common in the telecommunication industry, for example to protect the splice points of telecommunication lines for harsh environmental conditions. In this case, the flame retardant may be premixed into one or both parts of the encapsulant mixture to form a stable emulsion. The two parts of the encapsulant mixture are then stored in separate receptacle until just prior to dispensing. At this point, the two parts of the formulation are combined and mixed together. The mixture can then be introduced into a sleeve or mold that surrounds the splices. Because of the relatively low initial viscosity of the inventive encapsulant material, it will flow around and between the cables and splices contained within the sleeve displacing air and eliminating water infiltration path ways.

Various modifications and alterations of this disclosure may be made by those skilled in the art without departing from the scope and spirit of this disclosure, and it should be understood that this disclosure is not to be unduly limited to the illustrative embodiments set forth herein.

1. A composition comprising:
40-80 wt. % of an encapsulant comprising 60 to 80 parts by weight of hydrocarbon oil suspended in a cross-linked polymer matrix; and
a liquid flame retardant.

2. The composition of claim 1, wherein the liquid flame retardant comprises between about 30% and about 60% by weight of the composition.

3. The composition of claim 2, wherein the liquid flame retardant comprises between about 40% and about 50% by weight of the composition.

4. The composition of claim 1, wherein at least a portion of the liquid flame retardant forms a dispersed liquid phase in a continuous oil-rich phase.

5. The composition of claim 4, wherein the oil-rich phase comprises less than 15% of the liquid flame retardant dissolved in the oil-rich phase.

6. The composition of claim 4, wherein the oil-rich phase comprises less than 10% of the liquid flame retardant dissolved in the oil-rich phase.

7. The composition of claim 1, wherein the liquid flame retardant is one of a bisphenol A bis-(diphenyl phosphate) and a resorcinol bis-(diphenyl phosphate).

8. The composition of claim 1, wherein the encapsulant comprises 20 to 40 parts by weight admixture of an anhydride functionalized compound.

9. The composition of claim 1, wherein the composition has a flame retardant rating of V-2 when tested in accordance with UL-94 vertical burning test (Oct. 29, 1996).

10. The composition of claim 1, wherein the composition has a flame retardant rating of V-0 when tested in accordance with UL-94 vertical burning test (Oct. 29, 1996).

11. The composition of claim 1, wherein the composition provided environmental protection for optical connections.

12. The composition of claim 1, wherein the composition provided environmental protection for electrical connections.

13. A composition comprising:
40-70 wt. % of an encapsulant that includes an admixture of 20 to 40 parts by weight of an anhydride functionalized compound, 60 to 80 parts by weight of hydrocarbon oil, and
a liquid flame retardant.

14. The composition of claim 13, wherein at least a portion of the liquid flame retardant forms a dispersed liquid phase in a continuous oil-rich phase.
